(19) United States
(12) Patent Application Publication
(10) Pub. No.: US 2012/0312381 A1
(43) Pub. Date: Dec. 13, 2012

(54) Fuel Loading of Gaseous Fuel in Liquid Metal Cavitation Reactors

(75) Inventor: Naresh Mahamuni, Nevada City, CA (US)

(73) Assignee: Impulse Devices Inc., Grass Valley, CA (US)

(21) Appl. No.: 13/490,793

(22) Filed: Jun. 7, 2012

Related U.S. Application Data
(60) Provisional application No. 61/494,502, filed on Jun. 8, 2011.

(51) Int. Cl. F17D 3/00; F04F 1/00

(52) U.S. Cl. 137/1; 137/154

(57) ABSTRACT

A system and method for loading gases or other soluble fuel or catalyst materials into a liquid cavitation medium such as a liquid metal, which may be cavitated under static pressure so as to cause a desired energetic reaction in the dissolved gaseous fuel substance at the cavitation sites. Examples of liquid cavitation media can include liquid metals such as liquid gallium, and examples of dissolved gaseous fuel substances can include deuterium. Sufficiently intense cavitation (for example carried out under high static pressures) may provide energetic reactions in the fuel that release subatomic particles therefrom such as neutrons. The present system and method may be used to load such gaseous fuels into other liquid metal systems, including systems that are non-cavitation-based or that cause cavitation in the liquid by means other than the acoustical drivers described in the preferred embodiments.

### TECHNICAL FIELD

The present disclosure is directed to introduction of a fuel into a liquid metal and causing a reaction therein. Specifically, aspects are directed to introducing a gaseous fuel into a liquid metal such as would be used in a reactor chamber or cavitation reaction resonator.

### RELATED APPLICATIONS

This application is a non-provisional deriving from and claiming the full benefit and priority of U.S. Provisional Application No. 61/494,502, filed on Jun. 8, 2011, entitled “Fuel Loading of Gaseous Fuel for Reactions in Liquid Metal,” which is hereby incorporated by reference.

### BACKGROUND

The present disclosure will not describe in much detail general work on introduction of gases into liquids. Those skilled in the art understand that certain gases can be dissolved into certain liquids under certain conditions. Various industrial and other applications rely on introduction and retention of gases into liquids. For example, beverages are carbonated by applying carbon dioxide to the drink. Fish tanks are kept aerated by bubbling air from an air pump into an aerator stone or similar apparatus to allow small air bubbles to float up through the fish tank's water. The contact between the air bubbles and the water allows the air to dissolve into the water and allows the fish to therefore extract oxygen from the water in order to live. The total surface area between the gas and the liquid as well as the amount of time that the contact between the gas and the liquid is achieved both positively contribute to the amount of gas dissolved into the liquid. Of course, the concentration of gas in the liquid, which may change over time, also determines the rate at which the liquid will take up the gas and the total amount of gas that can be dissolved into the liquid.

### SUMMARY

The present application is concerned with systems and methods for introducing gases into liquids in the context of gaseous fuel loading of substances to obtain desired reactions in reactor chambers, acoustic resonators, and so on.

A system and method for loading gases or other soluble fuel or catalyst materials into a liquid cavitation medium such as a liquid metal, which may be cavitated under static pressure so as to cause a desired energetic reaction in the dissolved gaseous fuel substance at the cavitation sites. Examples of liquid cavitation media can include liquid metals such as liquid gallium, and examples of dissolved gaseous fuel substances can include deuterium. Sufficiently intense cavitation (for example carried out under high static pressures) may provide energetic reactions in the fuel that release subatomic particles therefrom such as neutrons. The present system and method may be used to load such gaseous fuels into other liquid metal systems, including systems that are non-cavitation-based or that cause cavitation in the liquid by means other than the acoustical drivers described in the preferred embodiments.

### BRIEF DESCRIPTION OF THE DRAWINGS

FIG. 1 illustrates an exemplary cavitation chamber coupled to electrical driving, control and fluid processing systems;

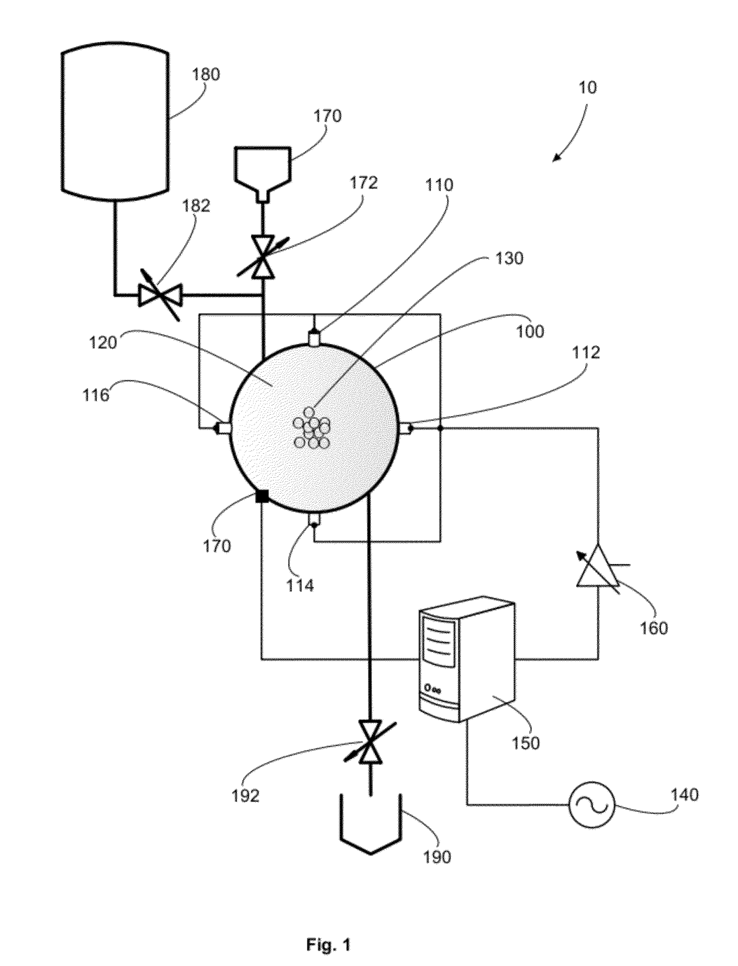

FIG. 2 illustrates an exemplary cavitation chamber with piezoelectric drivers coupled thereto;

FIG. 3 illustrates an exemplary cross section of a cavitation chamber showing an embodiment where cavitation occurs within a spherical chamber;

FIG. 4 illustrates an exemplary arrangement of a gaseous fuel loading apparatus for use with cavitation systems;

FIG. 5 illustrates an exemplary system for cavitation in a liquid metal medium in a spherical cavitation chamber with coupling to a gaseous fuel loading and monitoring arrangement; and

FIG. 6 illustrates an exemplary system for calibration of the gaseous fuel content within the systems described above for dissolving said gaseous fuel within a liquid metal.

### DETAILED DESCRIPTION

As mentioned above, it is useful to have systems and methods for introducing gases into liquids. More specifically, in the context of cavitation systems and reaction chambers or reactors, it is disclosed that introduction of gaseous fuel material into liquid metal substances can be achieved in several preferred modes and arrangements. Those skilled in the art should be able to understand from the present disclosure how and where the present disclosure can be generalized to other situations still benefiting from the inventions herein.

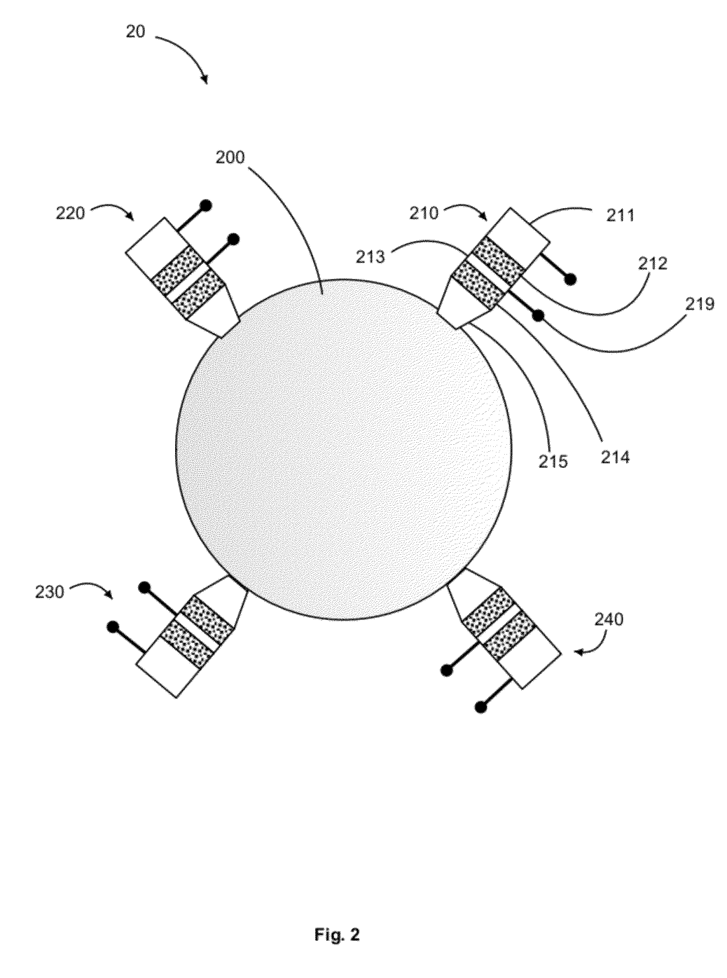

FIG. 2 illustrates an exemplary system 20 for causing cavitation or acoustically driven reactions within a spherical resonator. Spherical resonator 200 may comprise a solid shell, e.g. comprising a metal such as stainless steel or other material suitable for holding a liquid and for mechanical coupling to related accessory devices. Note that the present invention is not limited to spherical shaped resonators, but may be used with other resonators having other sizes and shapes than those discussed here and in the context of these preferred embodiments.

One or more acoustic drivers 210, 220 and 240 are coupled to the exterior surface of resonator 200. In one embodiment, exemplary acoustic driver 210 provides ultrasonic energy through transduction of an electrical driving signal into an acoustical corresponding wave that propagates from driver 210 into resonator 200 and then into the fluid contained within resonator 200. More specifically by way of example, acoustic driver 210 may comprise a conical or elliptic portion 215 that is directly or indirectly coupled to the shell of resonator 200. At least one transductive layer 214, 212 is included to cause a resonance that is carried from the body of acoustic driver 210 into resonator 200 through said conical or elliptical portion 215. Electrical connections 219 provide for electrical driving signals to be provided to conducting layers 213 and 211 of driver 210. The drivers 210, 220, 230 and 240 may be secured to the body of resonator 200 through any appropriate mechanical means such as welding, epoxy connection, a threaded connection, pressure fitting, or other means. In some embodiments, as shown, the portion of the driver 210 that attaches to the shell of resonator 200 is tapered or shaped in a way such that a small surface area or footprint of acoustic driver is coupled to the shell of resonator 200.

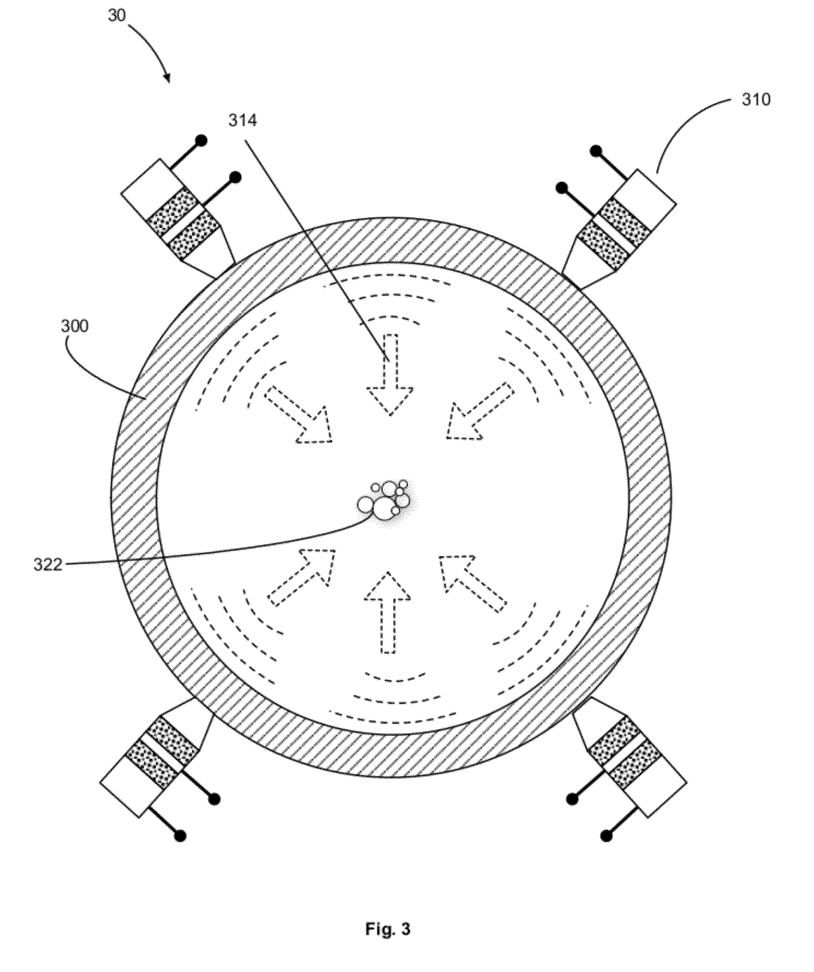

FIG. 3 illustrates an acoustic resonator 30. Acoustic resonator 30 comprises a three-dimensional shell 300, which may be a spherical shell that is made of a solid material such as a metal, e.g., stainless steel or other suitable material. Resonator shell 300 is adapted for coupling with a plurality of acoustic energy sources or transducers 310. Transducers 310 may mechanically and acoustically coupled to an external surface of shell 300, for example, by bonding or threading or welding or other coupling means.

Acoustic energy sources 310, e.g., ultrasound transducers, are located on the surface of resonator shell 300 as desired for a particular application. In some embodiments, a plurality of transducers 310 are coupled to a spherical resonator 30 so that the transducers 310 deliver to resonator shell 300 an ultrasonic energy at a given resonance frequencies of transducers 310. Shell 300 transmits the ultrasound energy from transducers 310 to a medium contained within shell 300. In some embodiments, the medium is a liquid such as water.

In a preferred embodiment, a spherical resonator shell 300 hold within it a liquid such as water, into which ultrasound energy is delivered and propagates inward from the shell 300 towards the center of the spherical resonator 30. As discussed earlier, for given parameters of acoustic driving energy and geometry of resonator 30 and other factors, acoustic cavitation 322 may take place at or near a central volume within resonator 30. Ultrasonic energy 314 resulting in cavitation 322 at or near the center of resonator 20 may cause changes in the material within resonator 30, such changes depending on the nature of the material within the resonator 30 and also depending on the duration and energy level and frequency of the applied ultrasonic energy.

In one or more preferred embodiments, the contents of resonator 30 are placed under a greater than ambient (e.g., atmospheric) static pressure during the cavitation activity so as to increase the intensity or quantity of cavitation activity in or near the cavitation bubbles at 322. In an embodiment, the increased cavitation intensity results in an increased maximum pressure in a cavitation volume and concomitant transformations of materials and/or energies in said cavitation volume or location. In an embodiment, the increased cavitation intensity results in an increased maximum temperature in a cavitation volume and concomitant transformations of materials and/or energies in said cavitation volume or location. It has been observed that intense cavitation can lead to release of energy in various forms, such as the release of photons, gamma rays, and other known transformations. The present discussion comprehends the scaling up of the present system and pressure and related phenomena to levels supported by the design of the system and the physics underlying the transformations above, including those that may result from one of ordinary skill taking the present disclosure and making quantitative or qualitative modifications to the present preferred embodiments to arrive at such transformations.

Energy or subatomic particles released as a result of the above transformations and phenomena may be captured by other means coupled to the present apparatus, including particle or energy detectors. These particles or energies may also be used in processes as would be appreciated by those skilled in the art, and may in some instances replace traditional sources of such energy or particles. Since the loading (type and amount) of gas dissolved or introduced into the liquid undergoing cavitation may vary and may be controlled, it is possible to control and vary the nature of the energetic reactions taking place in the resonator 30. In one embodiment, a deuterium gas is loaded into a liquid metal, for example liquid Gallium, which is then subjected to high intensity acoustic cavitation under static pressure to cause a desired energetic reaction and resulting energy and/or particulate emissions from the region in which the cavitation is occurring. In one embodiment, under appropriate conditions, intense thermal release resulting from the cavitation bubble formation and collapse in the cavitation zone may result in fusion reactions and may result in the release of subatomic particles and energy therefrom, including a release of neutron particles.

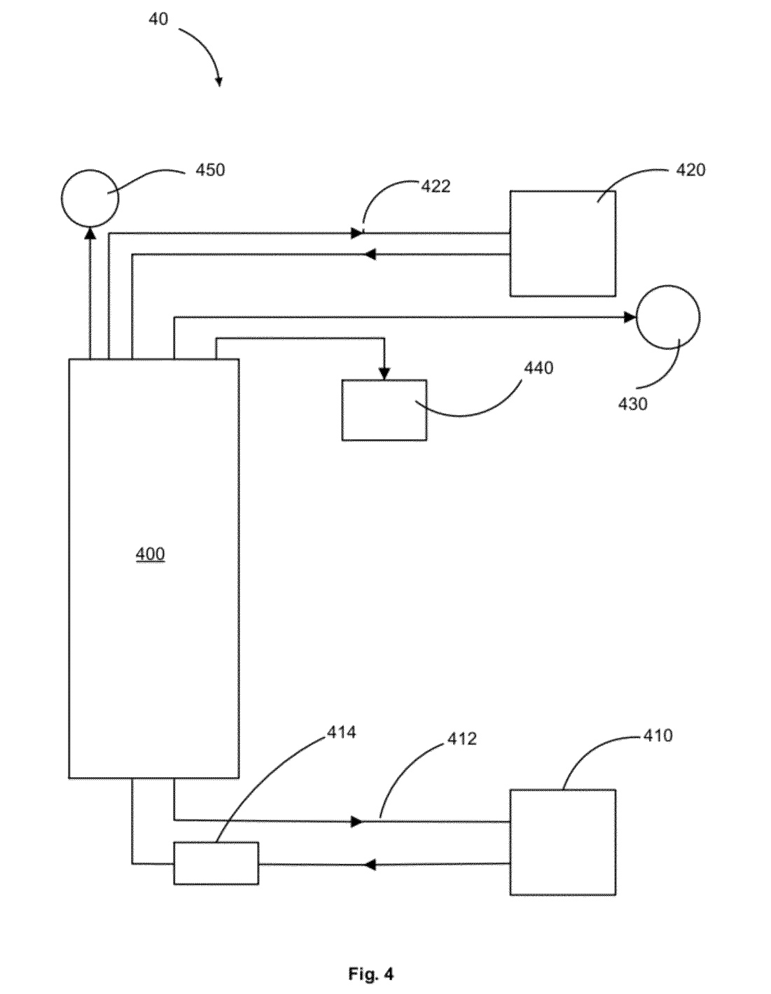

FIG. 4 illustrates an exemplary system for introducing a gaseous fuel into a liquid substance such as a liquid metal. A column 400 may be filled or substantially filled with the desired liquid, e.g. a liquid metal such as gallium, into which the gaseous fuel is to be loaded. The liquid metal column ay be an upright cylindrical column, where the liquid is placed inside the upright cylindrical container, which may be made of a transparent or optically permissive material to allow operators to see the level of filling of the column 400 by its liquid contents.

A liquid re-circulating pump 410 can re-circulate the liquid metal to and from the liquid metal column 400. Inlet and outlet lines 412 allow passage of the liquid between liquid metal column 400 and the liquid metal re-circulating pump 410. Optionally, a fluid processing component or components 414 may be present in one of the legs of re-circulating lines 412. For example, a filter or a temperature control component may be included in fluid processing system 414.

A gas circulation pump 420 is connected to an upper portion of the liquid metal column 400. For example, inlet and outlet lines 422 may connect the gas circulation pump 420 with appropriate couplings at or near the top of liquid metal column chamber 400, realizing that gravity would normally cause any gas content inside of column 400 to be at or near said upper portion of the column 400. A vacuum pump 440 is also coupled to the upper portion of the liquid metal column chamber 400. A pressure gauge 450 is furthermore coupled to the upper portion of the liquid metal column chamber 400 to monitor the pressure of the gas within chamber 400.

A residual gas analyzer (RGA) 430 is coupled to an upper portion of liquid metal column chamber 400. The RGA may for example be from SRS, such as the SRS-QMS-100 analyzer. The system may also include a quadropole mass spectrometer (QMS) for monitoring and analyzing the content of the gas in the upper portion of the liquid metal chamber 400.

The above apparatus for introducing gas into a liquid metal provided in a liquid metal column 400 allows gas circulation pump 420 to push the gaseous fuel substance down to a location near the bottom of the liquid metal column, which gaseous fuel may then bubble up by force of gravity and buoyancy through the liquid metal towards the top of the liquid metal column. Bubbles of said gaseous fuel will interact with and diffuse into the liquid metal during their journey from the bottom to the top of the liquid metal column. In so doing, the gaseous fuel becomes chemically introduced into the liquid metal, which dissolved gas and liquid metal can then be introduced into a desired reactor chamber, such as an acoustic cavitation reaction chamber as will be discussed below.

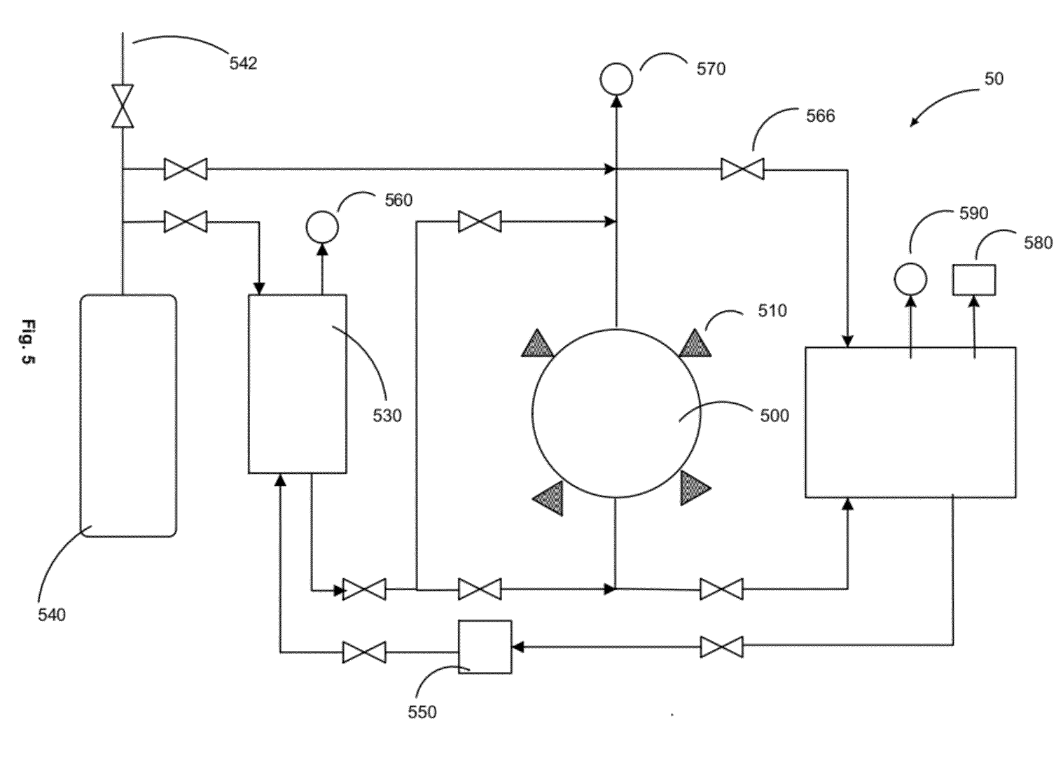

FIG. 5 illustrates an exemplary system for carrying out reactions on a liquid substance into which a gaseous fuel has been introduced as described in the illustrative examples above. The reaction system 50 includes a cavitation chamber or resonator 500, which may comprise a spherical metallic shell capable of holding a liquid metal substance into which a gaseous fuel has been dissolved or introduced as previously described. Acoustic resonator 500 may be driven by one or more acoustical drivers 510, which may resonate at ultrasonic resonator frequencies depending on the mode and method of operation of the acoustic drivers 510.

A liquid metal column chamber 530 may be supplied with a gas from a gas cylinder or tank 540, which may be bubbled through a porous bubble generation system as discussed above into the liquid metal near the bottom of liquid metal column 530 and allowed to rise as gaseous bubbled through the column of liquid metal through the top of liquid metal column 530. This process may be controlled by gas analyzers or other chemical or electrochemical detectors disposed at or near liquid metal column 530 and the pressure of the liquid and/or gas within the column may be monitored by a pressure monitor 560. A liquid re-circulating pump 550 may provide the liquid metal containing the dissolved gaseous fuel to and from a reservoir 520, the reservoir 520 having a vacuum pump 580 and a residual gas analyzer and pressure sensor 590 coupled thereto. A source of gas may arrive from a location off-site through a line 542, which may be used to charge the contents of the gas cylinder 540. Other trace gases may be used to mix with the contents of gas cylinder 540 so that a concentration of gas within the liquid metal or a partial gas pressure may be determined to arrive at an optimum gaseous fuel concentration within the liquid metal that is being acted on in acoustic resonator 500. Valves 566 are used throughout the system as shown to allow isolation of portions of the system or for throttling a flow-rate of respected fluids or gases in fluid or gas lines in the system.

Acoustic drivers 510 cause an acoustical field within resonator 500 that then acts to cause acoustic cavitation at one or more locations within resonator 500, and in some cases to cause an acoustically driven reaction in or near the cavitation bubbles inside reaction chamber 500. In some cases, this may result in high temperature conditions in or at the liquid metal and where the liquid metal is infused with an appropriate gaseous fuel, the combination of energy provided by acoustic drivers 510 and the substances within resonator 500 undergoing cavitation may lead to a fusion reaction within resonator 500. Such fusion reactions may result in the generation of neutron particles, which can then be detected from within or outside resonator 500.

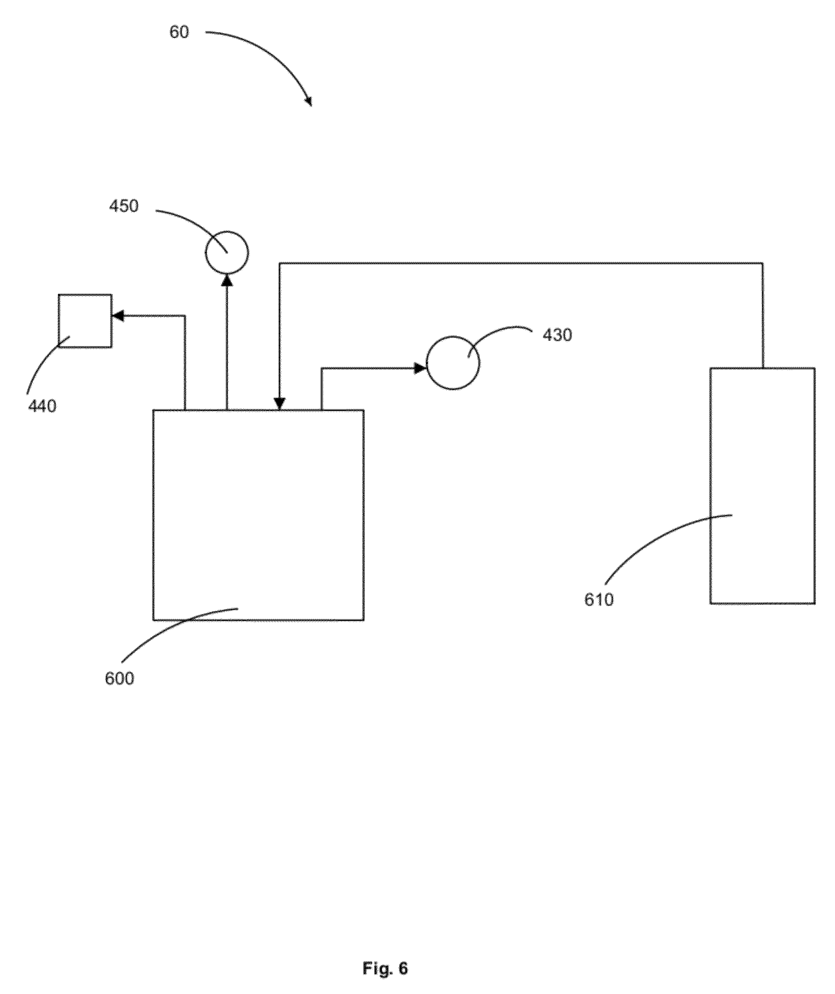

FIG. 6 illustrates an exemplary system 60 for calibration of the gaseous fuel content within the systems described above for dissolving said gaseous fuel within a liquid metal. A calibration chamber 600 is coupled to a gas cylinder 610 that may include deuterium gaseous fuel and which may include argon as well. A vacuum pump 440 is coupled to calibration chamber 600 and a pressure gauge 450 monitors the pressure within the calibration chamber 600. A residual gas analyzer (RGA) is also connected to calibration chamber 600 as discussed above. This system allows the operator to properly inject gaseous fuel such as deuterium into a liquid such as a liquid metal, e.g. liquid gallium, in the appropriate concentration for a reaction to be caused thereon. In a preferred embodiment, this system 60 is part of the systems described above for introducing a gaseous fuel into a liquid metal that is then introduced into an acoustical resonator chamber, upon which a cavitation reaction may be caused.

While the invention has been described and illustrated with specific preferred and exemplary embodiments, those skilled in the art would appreciate that numerous variations on the illustrative examples are possible and comprehended by the present disclosure and appended claims. Details that may not be necessary in order to implement and appreciate the invention, for example details as to manufacturing processes, chemical, mechanical and other arrangements and aspects for perfecting this technique for a given application, and so on, including ways of monitoring and controlling the present process and system, software instructions for programming such steps, are all within the grasp of those of ordinary skill in the present arts.

Therefore, what is claimed is:

1. A system for introducing a gaseous fuel into a liquid in an acoustic cavitation system, comprising:
a liquid supply unit that supplies a liquid to undergo cavitation;
a liquid reservoir that receives said liquid from said liquid supply unit and that supports said liquid in a liquid column;
a liquid circulation pump in liquid fluid communication with said liquid reservoir that circulates said liquid into and out of said liquid reservoir;
a gaseous fuel supply unit;
a gas injection unit that includes a gas diffuser proximal to a lower end of said liquid column, the gas injection unit being in gaseous fluid communication with a gas circulation pump, said gas injection unit receiving said gaseous fuel from gaseous fuel supply unit, and adapted and arranged to force said gaseous fuel into said diffuser at a gas injection pressure provided by said gas circulation pump, said gas diffuser further including a plurality of gas-permeable orifices that permit injection of said gaseous fuel at said gas injection pressure into said liquid in said reservoir, said gas injection unit, diffuser and liquid column disposed and arranged to permit injected gaseous fuel from said diffuser to enter into said lower end of said liquid column and to rise under the force of buoyancy up through said liquid column towards and upper end of said liquid column until a desired amount of gaseous fuel is introduced into said liquid; and
a gas analyzer proximal to said upper end of said liquid column that receives samples of gas from said system, and determines an amount of gaseous fuel present in said liquid, and that provides an output indicative of said amount of said gaseous fuel.

2. The system of claim 1, further comprising a cavitation resonator in fluid communication with said reservoir, constructed and arranged to receive liquid from said reservoir containing a pre-determined amount of said gaseous fuel, and said cavitation resonator.

3. The system of claim 2, further comprising at least one acoustic driver acoustically coupled to said resonator so as to provide acoustic energy to said resonator to cause cavitation within said liquid having the pre-determined amount of said gaseous fuel.

4. The system of claim 1, further comprising a vacuum pump coupled to a gas portion of said system so as to pump a gas from said gas portion out of said system.

5. A method for achieving a reaction in a fuel within a liquid cavitation medium, comprising:
dissolving a determined amount of a gaseous fuel substance into a liquid metal substance;
loading the liquid metal substance containing the dissolved gaseous fuel substance into a reaction chamber;
pressurizing the liquid metal and dissolved gaseous fuel substances to a static pressure greater than atmospheric pressure within said reaction chamber; and
cavitating said liquid metal and dissolved gaseous fuel substances within said reaction chamber so as to cause a cavitation driven reaction involving said gaseous fuel substance.

6. The method of claim 5, said cavitating comprising causing acoustic cavitation from an acoustic sound field from at least one acoustic transducer device coupled to said reaction chamber.

7. The method of claim 5, said cavitating comprising causing non-acoustic cavitation activity within said reaction chamber so as to accomplish cavitation therein.
